(19) United States
(12) Patent Application Publication
(10) Pub. No.: US 2013/0093262 A1
(43) Pub. Date: Apr. 18, 2013

(54) CONNECTOR MODULE AND PROCESSOR MODULE USING SAME

(71) Applicant: CHUANG-WEI TSENG, Tu-Cheng (TW)

(72) Inventor: CHUANG-WEI TSENG, Tu-Cheng (TW)

(73) Assignee: HON HAI PRECISION INDUSTRY CO., LTD., Tu-Cheng (TW)

(21) Appl. No.: 13/459,123

(22) Filed: Apr. 28, 2012

(30) Foreign Application Priority Data
Oct. 12, 2011 (TW) 100136983

(51) Int. Cl. G05F 5/00

(52) U.S. Cl. 307/151

(57) ABSTRACT

A connector module for providing power to a processor. The connector module includes a connector for accommodating the processor, an inverter, and a control chip. Both the converter and the control chip are set on the connector. The control chip is connected to the converter for converting an external power into at least one driving voltage adapted to the processor.

### TECHNICAL FIELD

The disclosure generally relates to connectors, and particularly, to a connector module for electrically connecting a central processing unit with an electric circuit.

### DESCRIPTION OF RELATED ART

A converting circuit may be needed between an external power source and a central processing unit (CPU) to convert a high voltage low current electrical power provided by the external power source to a low voltage high current electrical power which is adapted to the CPU. The CPU is set in a CPU socket on a mother board and the converting ciruit is set on the mother board and may be some distance from the CPU. Thus, a wire for transmitting the low voltage high current electrical power is vulnerable to transients or noise. Furthermore, the converting circuit needs to be specifically arranged and constructed according to the type of the CPU, which will increase the cost for developing new product.

Therefore, it is desirable to provide a connector module which can overcome the above-mentioned problems.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of a connector module, the connector module including a inverter.

FIG. 2 is a circuit diagram of one embodiment of the inverter of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

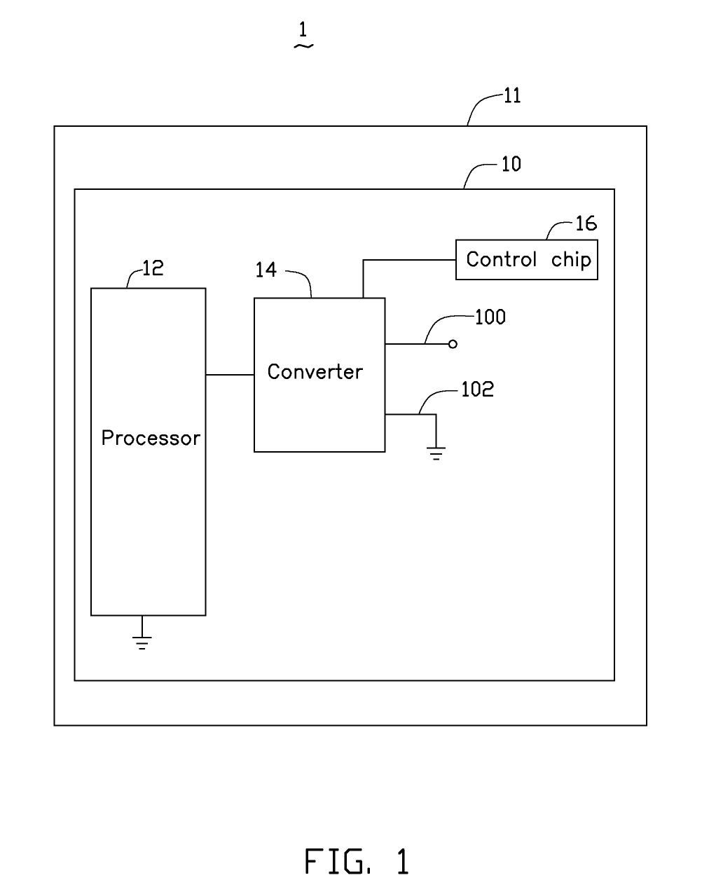

Refering to FIG. 1, in one embodiment, a connector module 1 includes a connector 10, and a processor 12, a converter 14, and a control chip 16 set or assemblied on the connector 10. The connector 10 is fixed on a circuit board 11 via a number of fasteners, for example, bolts or buckles, and electrical connected to the circuit board 11. The control chip 16 is configured for controlling the converter 14 to convert an external electrical power to a driving voltage adapted to the processor 12. In this embodiment, the processor 12 is a central processing unit (CPU). The connector 10 is a CPU socket.

The connector 10 includes an input terminal 100 and a ground terminal 102. The input terminal 100 connects with an external power source to receive an external electrical power. The ground terminal 102 is grounded. The processor 12 exchanges controlling signals with the circuit board 11 via the connector 10. In this embodiment, the circuit board 11 is a motherboard.

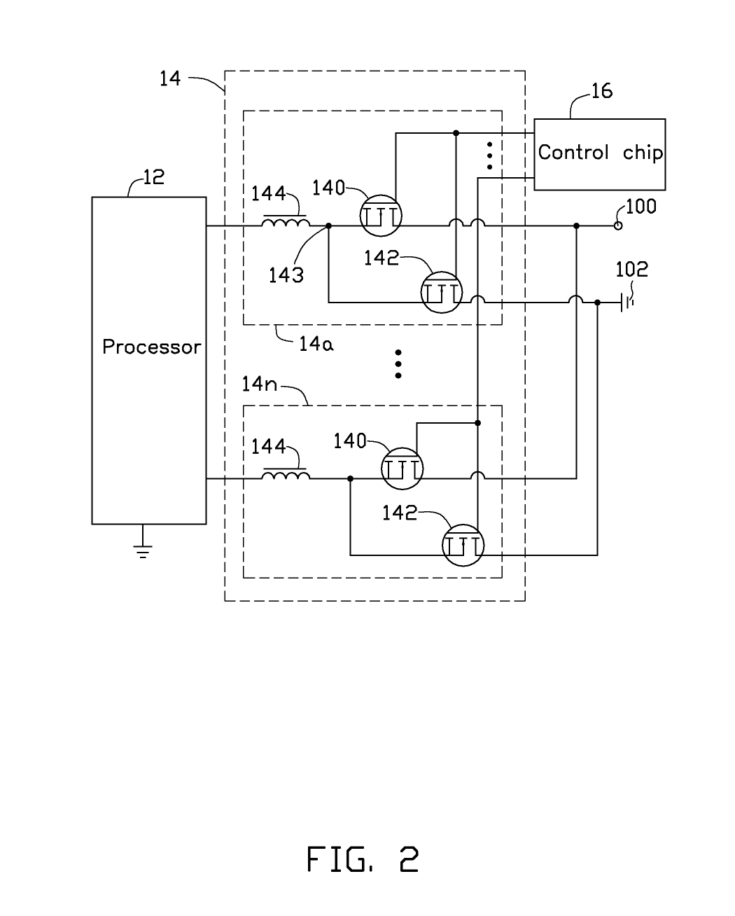

Referring to FIG. 2, the converter 14 includes at least one converting circuit 14a. The converting circuit 14a includes a first switch 140, a second switch 142, and an inductor 144. Each of the first switch 140 and the second switch 142 includes two conducting terminals and a controlling terminal The input terminal 100 is grounded via two conducting terminals of the first switch 140, the inductor 144, and the processor 12. One of the conducting terminals of the second switch 142 is connected to a node 143 between the first switch 140 and the inductor 144. The other conducting terminal of the second switch 142 is grounded via the ground terminal 102. The control chip 16 connects with the controlling terminals of both the first switch 140 and the second switch 142 for turning on or turning off the first switch 140 and the second switch 142. In this embodiment, both the first switch 140 and the second switch 142 are metal-oxide-semiconductor field effect transistors (MOSFETs). The controlling terminal is a gate electrode of the MOSFET. The two conducting terminals are respectively a source electrode and a drain electrode of the MOSFET.

In operation, the control chip 16 first turns on the first switch 140 and turns off the second switch 142. The external electrical power received by the input terminal 100 charges the inductor 144 and provide power to the processor 12. After the inductor 144 has been fully charged, the control chip 16 turns off the first switch 140 and turns on the second switch 142. The inductor 144 discharges and provides power to the processor 12.

A single converting circuit 14a only converts the external electrical power to a driving signal of one predetermined voltage value. If the processor 12 needs a number of driving signals at different predetermined voltage values, the converter 14 includes a number of converting circuits 14a-14n for converting the external electrical power to the driving signals with various predetermined voltage values. The control chip 16 connects with the first switches 140 and the second switches 142 of different converting circuits 14a-14n to switch on or cut off the first switches 140 and the second switches 142 of different converting circuits 14a-14n.

The connector module 1 integrates the converter 14 and the processor 12 into a one-piece or single-unit element to shorten the conducting distance between the converter 14 and the processor 12. Therefore, any transients and noise during the transmission of the electrical power is reduced. Furthermore, different types of processors 12 can be integrated with a suitable connector module 1. The circuit board 11 only needs to provide a standard power port and does not need to rearrange the converting circuits 14a-14n according to the different types of processor 12. Therefore, the cost for developing new product can be reduced.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. A connector module, comprising:
a connector;
a processor set on the connector;
a converter set on the connector and connected to the processor; and
a control chip set on the connector, connected to the converter, and configured for controlling the converter to convert an external electrical power to a driving voltage adapted to the processor.

2. The connector module of claim 1, wherein the connector comprises an input terminal and a ground terminal, the input terminal is configured for reciving the external electrical power, the ground terminal is configured for grounding the connector.

3. The connector module of claim 2, wherein the converter comprises at least one converting circuit, the converting circuit comprises a first switch, a second switch, and a inductor, each of the first switch and the second switch comprises two conducting terminals and a controlling terminal, the input terminal is grounded via two conducting terminals of the first switch, the inductor, and the processor, one of the conducting terminal of the second switch is connected to a node between the first switch and the inductor, the other conducting terminal of the second switch is grounded, the control chip connects with the controlling terminals of both the first switch and the second switch for turning on or turning off the first switch and the second switch.

4. The connector module of claim 3, wherein the control chip first turns on the first switch and turn off the second switch to make the external electrical power input via the input terminal to charge the inductor and provide power to the processor, after the inductor has been fully charged, the control chip turns off the first switch and turns on the second switch to discharge the inductor to continue to provide power to the processor.

5. The connector module of claim 3, wherein the first switch and the second switch are metal-oxide-semiconductor field effect transistor, the controlling terminal is a gate electrode of the metal-oxide-semiconductor field effect transistors, the two conducting terminals correspondingly are a source electrode and a drain electrode of the metal-oxide-semiconductor field effect transistors.

6. The connector module of claim 1, wherein the processor is a central processing unit.

7. The connector module of claim 1, wherein the connector is a central processing unit socket.

8. A processor module, comprising:
a circuit board;
a connector module mounted on the circuit board and electrically connected with the circuit board, the connector module comprising:
a connector;
an invertor mounted on the connector;
a control chip mounted on the connector, connected to the invertor, and configured for controlling the converter to convert an external electrical power to a driving voltage; and
a processor mounted on the connector, and electrically connected with the converter for receiving the driving voltage.

9. The processor module of claim 8, wherein the connector comprises an input terminal and a ground terminal, the input terminal is configured for reciving the external electrical power, the ground terminal is configured for grounding the connector.

10. The processor module of claim 9, wherein the converter comprises at least one converting circuit, the converting circuit comprises a first switch, a second switch, and an inductor, each of the first switch and the second switch comprises two conducting terminals and a controlling terminal, the input terminal is gournded via two conducting terminals of the first switch, the inductor, and the processor, one of the conducting terminal of the second switch is connected to a node between the first switch and the inductor, the other conducting terminal of the second switch is grounded, the control chip connects with the controlling terminals of both the first switch and the second switch for turning on or turning off the first switch and the second switch.

11. The processor module of claim 10, wherein the control chip first turns on the first switch and turns off the second switch to make the external electrical power input via the input terminal to charge the inductor and provide power to the processor, after the inductor has been fully charged, the control chip turns off the first switch and turns on the second switch to discharge the inductor to continue to provide power to the processor.

12. The processor module of claim 10, wherein the first switch and the second switch are metal-oxide-semiconductor field effect transistor, the controlling terminal is a gate electrode of the metal-oxide-semiconductor field effect transistors, the two conducting terminals correspondingly are a source electrode and a drain electrode of the metal-oxide-semiconductor field effect transistors.

13. The processor module of claim 8, wherein the processor is a central processing unit.

14. The processor module of claim 8, wherein the connector is a central processing unit socket.
